(19) United States
(12) Patent Application Publication
(10) Pub. No.: US 2017/0146051 A1
(43) Pub. Date: May 25, 2017

(54) Anti-loosen Screw Manufacturing Method and Screw Member Produced Thereby

(71) Applicant: Kuo-Chen Hung, Kaohsiung (TW)

(72) Inventor: Kuo-Chen Hung, Kaohsiung (TW)

(21) Appl. No.: 14/946,992

(22) Filed: Nov. 20, 2015

(51) Int. Cl. F16B 39/30; B21H 3/02; B21H 3/06

(52) U.S. Cl. CPC F16B 39/30; B21H 3/06; B21H 3/025

(57) ABSTRACT

A screw includes a shank portion, an outer thread portion and a laterally-extruded thread portion. The shank portion has an outer circumferential surface on which to form the outer thread portion having grooves. In a thread-rolling process, the laterally-extruded thread portions is formed by laterally extruding an inclined wall of one groove with respect to a longitudinal direction thereof such that a laterally-extruded portion is protruded in an adjacent groove and is tightly engaged with an inclined surface of a groove of inner threads of a screw hole

### BACKGROUND OF THE INVENTION

1. Field of the Invention

The present invention relates to an anti-loosen screw manufacturing method and a screw member produced thereby. Particularly, the present invention relates to the anti-loosen screw manufacturing method for forming a laterally-extruded thread portion.

2. Description of the Related Art

U.S. Pat. No. 6,454,506, entitled “ANCHOR BOLT WITH AN OUTER THREAD HAVING THREAD TURNS WITH DIFFERENT CROSS-SECTIONAL SHAPE,” discloses an anchor bolt having a substantially cylindrical stem and at least one thread provided on the stem. The thread extends from a free front end of the stem at least over a portion of a longitudinal extent of the stem.

The thread has a plurality of thread turns at least over one/third of the stem. A width decreases with an increase of a distance of a respective thread turn from the free front end of the stem, so that a distance between trailing and leading flanks of two following one another thread turns of the thread increases backwards.

A decrease of the width of the thread or an increase of the distance between the trailing flank and the leading flank can be suitable for intensifying an anchorage of the anchor bolt on constructions. However, the thread structure of the anchor bolt is unsuitable for effectively preventing the screw from loosening or falling off from a screw hole.

Further, Taiwanese Patent Publication No. TW-475670, entitled “IMPROVED STRUCTURE OF THREADS OF SCREWS,” discloses a screw having an anti-loosen structure. The screw includes a head, a shank and a plurality of slanted threads which extend along the shank. A predetermined section of the slanted threads is formed with a set of wavelike threads spaced apart from the head a predetermined distance.

The wavelike threads extend along the slanted threads and tilt to the adjacent slanted threads. In screwing operation, the wavelike threads are tightly engaged with corresponding threads of a screw hole. To a certain extent, the screw can be firmly locked in the screw hole to avoid unexpected loosening or falling off from the screw hole.

In fact, although the wavelike threads tilted to the adjacent slanted threads can provide a function of anti-loosen, it has deficiencies of complicated structures in the wavelike threads. Namely, the wavelike thread must be a single wavelike thread to regularly tilt to the adjacent slanted threads in a thread-rolling process. However, the additional wavelike threads further formed on the slanted threads result in difficulties in the thread-rolling process of the screws.

However, there is a need of improving the thread structure and the manufacturing method for providing an anti-loosen function of the screw after being screwed. The above-mentioned patent application publications are incorporated herein by reference for purposes including, but not limited to, indicating the background of the present invention and illustrating the situation of the art.

As is described in greater detail below, the present invention provides an anti-loosen screw manufacturing method and a screw member produced thereby. In thread-rolling process, a thread portion and a laterally-extruded thread portion are formed on a shank such that a groove of the thread portion is extruded to form one or a pair of laterally-extruded portions (e.g., two opposite extruded portions) and each of which are protruded in two adjacent grooves. In screwing operation, the two laterally-extruded portions are capable of engaging with inner threads of a screw hole for providing an anti-loosen function after being screwed in such a way as to eliminate the above problems of the conventional screw member.

### SUMMARY OF THE INVENTION

The primary objective of this invention is to provide an anti-loosen screw manufacturing method and a screw member produced thereby. In thread-rolling process, a thread portion and a laterally-extruded thread portion are formed on a shank such that a groove of the thread portion is extruded to form one or a pair of laterally-extruded portions and each of which are protruded in two adjacent grooves. In screwing operation, the two laterally-extruded portions are capable of engaging with inner threads of a screw hole for providing an anti-loosen function. Advantageously, the screw member of the present invention is successful in providing an anti-loosen function after being screwed.

The anti-loosen screw manufacturing method in accordance with an aspect of the present invention includes:

combining a main die plate with a protruded die plate to form a combined die plate;

utilizing the main die plate of the combined die plate to execute a thread-rolling process on an outer circumferential surface of a shank portion to form an outer thread portion which includes a plurality of grooves; and

utilizing the protruded die plate of the combined die plate to execute an extrusion-forming process to form at least one or a plurality of laterally-extruded thread portions on one of the grooves of the outer thread portion in the thread-rolling process;

wherein each of the laterally-extruded thread portions is formed by laterally extruding at least one inclined wall of the groove of the outer thread portion with respect to a longitudinal direction thereof such that at least one laterally-extruded portion is protruded in an adjacent groove of the laterally-extruded groove for engaging with an inner thread of a screw hole; and

wherein the laterally-extruded thread portion widens a width of the groove such that the laterally-extruded portion is tightly engaged with an inclined surface of a groove of the inner thread of the screw hole.

The anti-loosen screw manufacturing method in accordance with another aspect of the present invention includes:

combining a main die plate with a protruded die plate to form a combined die plate;

utilizing the main die plate of the combined die plate to execute a thread-rolling process on an outer circumferential surface of a shank portion to form an outer thread portion which includes a plurality of grooves; and

utilizing the protruded die plate of the combined die plate to execute an extrusion-forming process to form at least one or a plurality of laterally-extruded thread portions on one of the grooves of the outer thread portion in the thread-rolling process;

wherein each of the laterally-extruded thread portions is formed by laterally extruding two inclined walls of the groove of the outer thread portion with respect to a longitudinal direction thereof such that two opposite laterally-extruded portions are protruded in a first adjacent groove and a second adjacent groove of the laterally-extruded groove for engaging with inner threads of a screw hole; and

wherein the laterally-extruded thread portion widens a width of the groove such that the two opposite laterally-extruded portions are tightly engaged with two inclined surfaces of two adjacent grooves of the inner threads of the screw hole.

The anti-loosen screw in accordance with an aspect of the present invention includes:

a shank portion provided with an outer circumferential surface;

an outer thread portion formed on the outer circumferential surface of the shank portion in a thread-rolling process, with the outer thread portion including a plurality of grooves; and

at least one or a plurality of laterally-extruded thread portions formed on one of the grooves of the outer thread portion in the thread-rolling process;

wherein each of the laterally-extruded thread portions is formed by laterally extruding at least one inclined wall of the groove of the outer thread portion with respect to a longitudinal direction thereof such that a first laterally-extruded portion is protruded in a first adjacent groove of the laterally-extruded groove for engaging with an inner thread of a screw hole; and

wherein the laterally-extruded thread portion widens a width of the groove such that the first laterally-extruded portion is tightly engaged with an inclined surface of a groove of the inner thread of the screw hole.

In a separate aspect of the present invention, two of the plurality of laterally-extruded thread portions has an included angle with respect to a longitudinal axis of the shank portion.

In a further separate aspect of the present invention, the included angle is 180°, 120°, 90°, 72° or 60°.

In yet a further separate aspect of the present invention, the plurality of laterally-extruded thread portions are equal-spaced apart to form a plurality of equal-spaced engaging points for engaging with the inner thread of the screw hole.

In yet a further separate aspect of the present invention, the outer thread portion has at least one thermal treatment layer to intensify strength of the laterally-extruded thread portion.

In yet a further separate aspect of the present invention, the laterally-extruded thread portion has a recession formed in a bottom surface of the groove and extended along the longitudinal direction thereof.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a flow chart of an anti-loosen screw manufacturing method in accordance with a preferred embodiment of the present invention.

FIG. 2 is a fragment side view of an anti-loosen screw in accordance with a first preferred embodiment of the present invention.

FIG. 3 is another fragment side view of the anti-loosen screw in accordance with the first preferred embodiment of the present invention.

FIG. 3A is a partially enlarged side view, in FIG. 3, of the anti-loosen screw in accordance with the first preferred embodiment of the present invention.

FIG. 4 is a perspective view of a combined die plate applied in the anti-loosen screw manufacturing method in accordance with the preferred embodiment of the present invention.

FIG. 5 is a bottom view of the anti-loosen screw having a plurality of the laterally-extruded thread portion in accordance with a second preferred embodiment of the present invention.

FIG. 6 is a flow chart of the anti-loosen screw manufacturing method in accordance with the third preferred embodiment of the present invention.

FIG. 7 is a fragment side view of the anti-loosen screw in accordance with a third preferred embodiment of the present invention.

### DETAILED DESCRIPTION OF THE INVENTION

It is noted that an anti-loosen structure in accordance with the preferred embodiment of the present invention can be applicable to various screw nuts (e.g., hex flange nuts, hex slotted nuts, square nuts or wing nuts having inner threads for engaging with outer threads of screws or the like), bolts or screws, including for example, including machine screws, self-tapping screws, hexagon and hexagon socket screws, shoulder screws, Sems screws or other special screws, which are not limitative of the present invention. The anti-loosen screw manufacturing method and the screw member in accordance with the preferred embodiment of the present invention are applicable to various international standards, including ISO (International Organization for Standardization), ANSI (American National Standards Institute), JIS (Japanese Industrial Standards), DIN (German National Standards) and BSW (British Standard Whitworth) etc.

Further, the anti-loosen screw or screw nuts in accordance with the preferred embodiment of the present invention is made of various complex materials, metals or metal alloys, including magnesium, magnesium alloy, aluminum, aluminum alloy, stainless steel, low-carbon steel (mild steel), medium carbon steel, alloy steel, bronze, other metal (e.g., nonferrous metals) and metal alloy, for example.

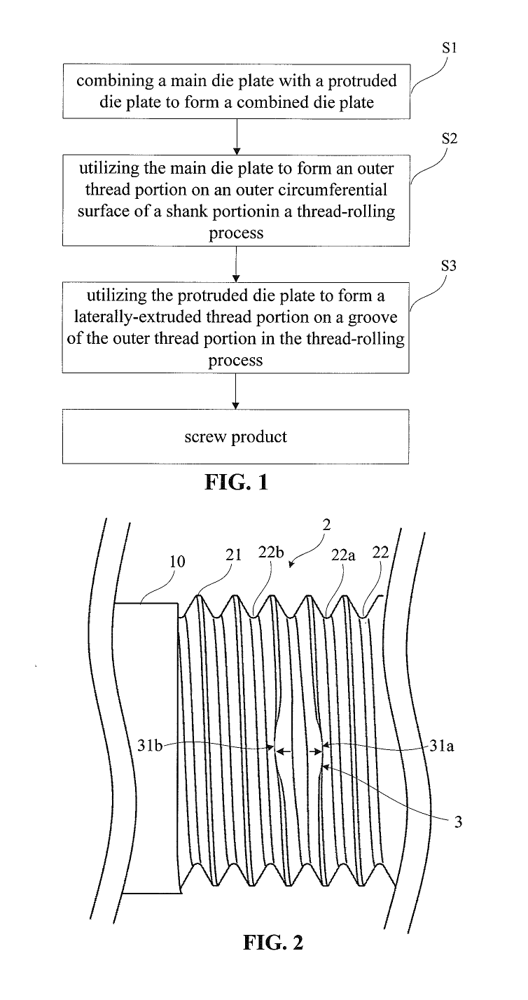

Referring now to FIGS. 1-3A, an anti-loosen screw of a first preferred embodiment of the present invention includes a head portion 1, a shank portion 10, an outer thread portion 2 and at least one laterally-extruded thread portion 3. The shank portion 10 includes an outer circumferential surface on which to form the outer thread portion 2, including a plurality of threads 21 and a plurality of grooves 22. By way of example, the head portion 1 is formed with various types, including a slotted type, a Phillips recess type, a square socket type, a hexagon type, an indented hexagon type, a slotted and square socket type, a slotted and Phillips combination type, a plane hexagon type, an H type, a TX type, a TX tamper resistant type and a PZ drive type, which are not limitative of the present invention.

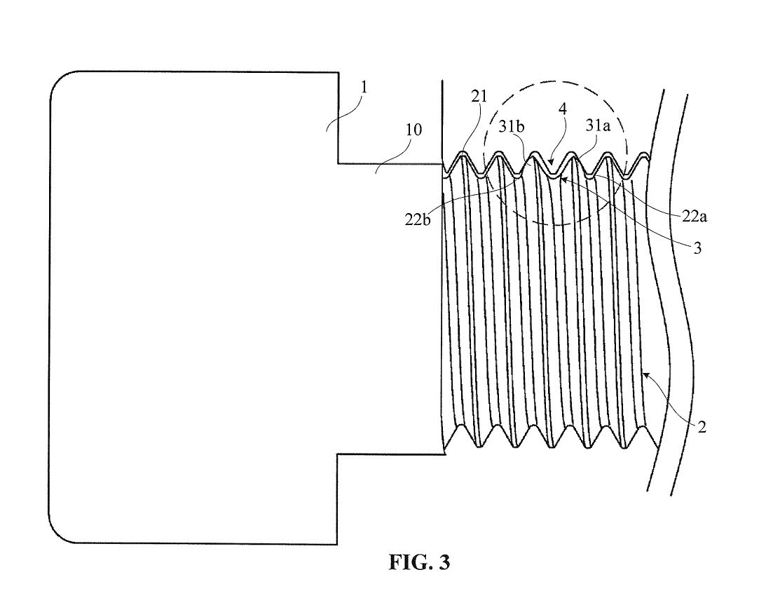

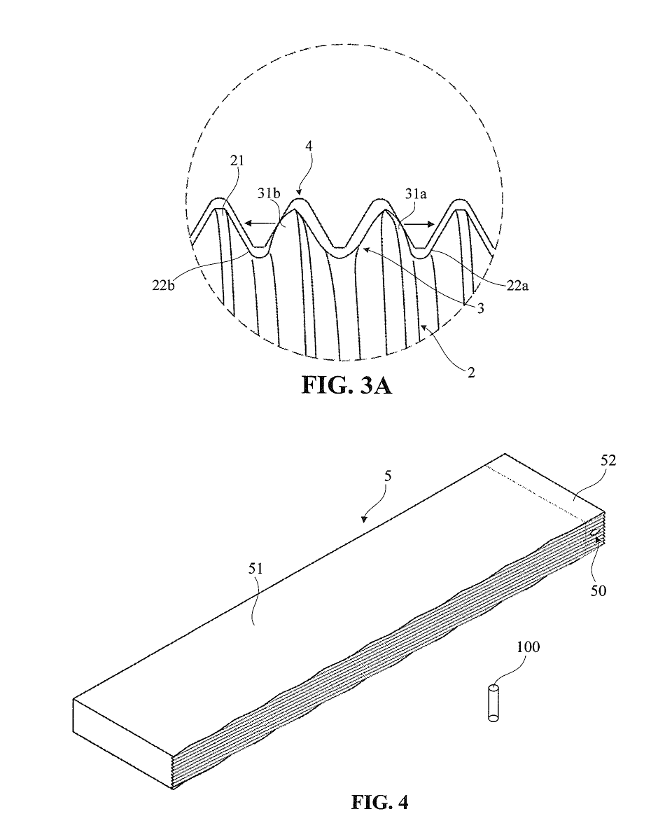

With continued reference to FIGS. 1-3A, by way of example, the laterally-extruded thread portion 3 has two opposite laterally-extruded portions 31a, 31b formed on a first inclined surface of a first adjacent groove 22a and a second inclined surface of a second adjacent groove 22b of the laterally-extruded groove 22. The two opposite laterally-extruded portions 31a, 31b bulge in the first adjacent groove 22a and the second adjacent groove 22b in opposite lateral direction with respect to a longitudinal direction of the laterally-extruded groove 22, shown as two opposite arrows in FIG. 3A. In screwing operation, two opposite laterally-extruded portions 31a, 31 b are tightly engaged with two inclined surfaces of two adjacent grooves of inner threads 4 (e.g., formed in a screw hole or a nut) for preventing the screw or the nut from unexpectedly loosening or falling off from each other.

Turning now to FIGS. 1-4, the anti-loosen screw manufacturing method of the first preferred embodiment of the present invention includes the step S1: mechanically combining a main die plate 51 with a protruded die plate 52 to form a combined thread-rolling die plate 5. The protruded die plate 52 has a protrusion 50, as shown in right portion of FIG. 4, or a round-shaped protrusion member received in an assembling hole provided on a thread-rolling surface of the protruded die plate 52. In a preferred embodiment, the protruded die plate 52 is received in an assembling hole provided on a thread-rolling surface of the main die plate 51.

With continued reference to FIGS. 1-4, the anti-loosen screw manufacturing method of the first preferred embodiment of the present invention includes the step S2: utilizing the main die plate 51 to roll threads 21 on the outer circumferential surface of the shank portion 10 to form the outer thread portion 2 which includes a plurality of the threads 21 and a plurality of the grooves 22 with regular sizes.

By way of example, the type of the threads 21 formed on the outer circumferential surface of the shank portion 10 are a single thread, a double thread, a high-low thread, a tri-lobular thread or other thread shape, which are not limitative of the present invention.

With continued reference to FIGS. 1-4, the anti-loosen screw manufacturing method of the first preferred embodiment of the present invention includes the step S3: utilizing the protrusion 50 of the protruded die plate 52 to roll at least one or a plurality of the laterally-extruded thread portions 3 on one of the grooves of the outer thread portion in the thread-rolling process. The laterally-extruded thread portion 3 has a recession formed in a bottom surface of the predetermined groove 22 and extended along the longitudinal direction thereof.

Referring again to FIGS. 2-3A, the laterally-extruded thread portion 3 is formed by laterally extruding two inclined walls of the predetermined groove 22 of the outer thread portion 2 with respect to a longitudinal direction thereof such that the two opposite laterally-extruded portions 31a, 31b are protruded in the first adjacent groove 22a and the second adjacent groove 22b of the laterally-extruded groove 22 for engaging with the inner threads 4 of the screw hole. The laterally-extruded thread portion 3 widens a width of the predetermined groove 22 such that, in screwing operation, the two opposite laterally-extruded portions 31a, 31b are tightly engaged with two separate inclined surfaces of two adjacent grooves of the inner threads 4 opposite each other.

Turning now to FIG. 5, the anti-loosen screw of a second preferred embodiment of the present invention includes four laterally-extruded thread portions 3 which are equal-spaced apart with a predetermined included angle (i.e., 90° with respect to the longitudinal axis of the shank portion 10) to form a plurality of equal-spaced engaging points for engaging with the inner thread 4 of the screw hole. In a preferred embodiment, the predetermined included angle is 180°, 120°, 72° or 60° which are formed with two, three, five or six of the laterally-extruded thread portions 3, respectively.

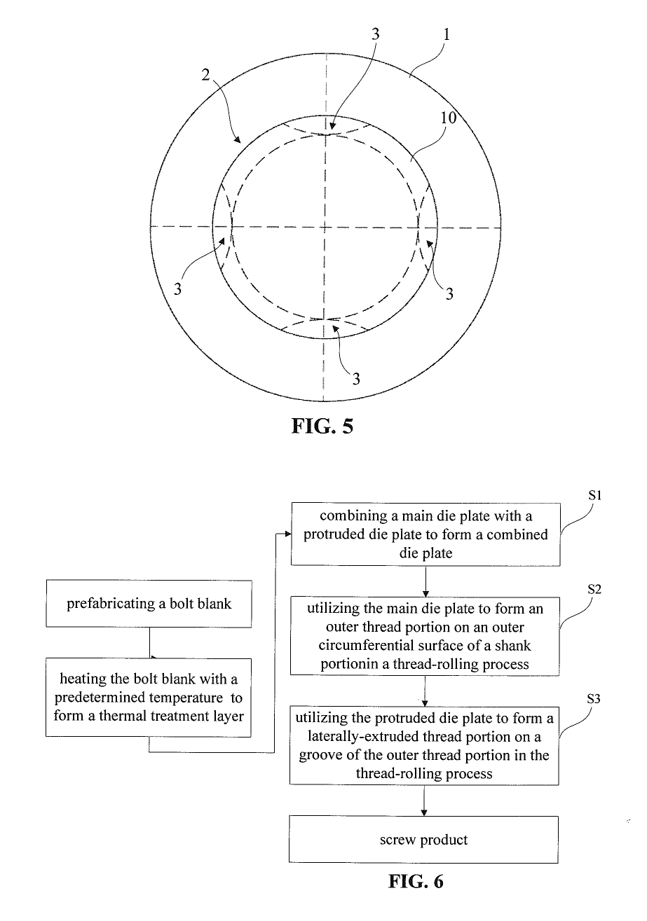

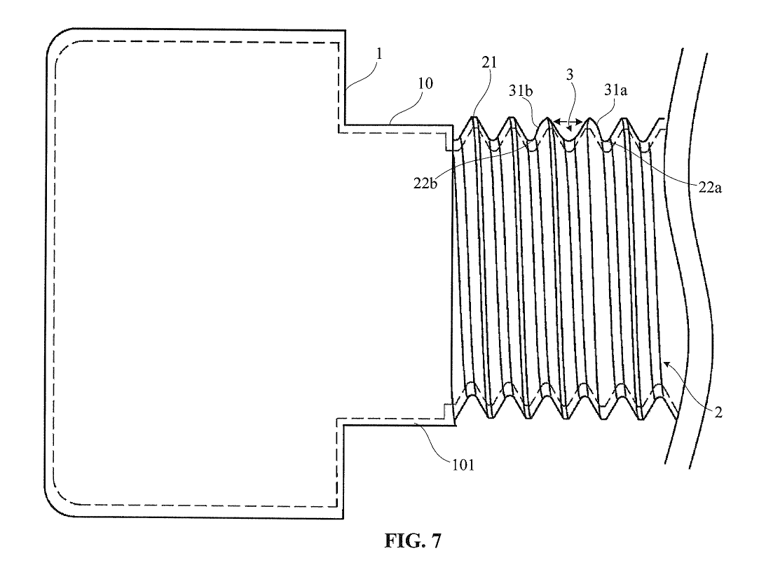

Turning now to FIGS. 4, 6 and 7, the anti-loosen screw manufacturing method of the third preferred embodiment of the present invention includes a first pretreatment step of: prefabricating a bolt blank 100. The bolt blank 100 is selected from magnesium or aluminum wires, rods or ingots. By way of example, the magnesium or aluminum wires, rods or ingots are made of magnesium or aluminum alloys to have a predetermined diameter suitable for forming a magnesium or aluminum screw, fastener or nut.

With continued reference to FIGS. 4, 6 and 7, the anti-loosen screw manufacturing method of the third preferred embodiment of the present invention includes a second pretreatment step of: heating the bolt blank 100 in a heating mold device or a heater with a predetermined temperature (e.g., 100° C. and 300° C.) to form at least one thermal treatment layer 101 on outer surfaces of the head portion 1 and the shank portion 10 for enhancing mechanical properties.

With continued reference to FIGS. 4, 6 and 7, the anti-loosen screw manufacturing method of the third preferred embodiment of the present invention includes steps S1 to S3 which are identical with those in the first embodiment and the detailed description will be omitted. The bolt blank 100 can further processed by cold forging or warming forging. The head portion 1 is formed by a screw heading machine and the outer thread portion 2 is formed by a thread rolling machine. In a preferred embodiment, at least one or a plurality of second thermal treatment layers are formed on a first thermal treatment layer of the anti-loosen screw according to different needs. The first thermal treatment layer and the second thermal treatment layer have different thicknesses and hardness.

Although the invention has been described in detail with reference to its presently preferred embodiment, it will be understood by one of ordinary skills in the art that various modifications can be made without departing from the spirit and the scope of the invention, as set forth in the appended claims.

What is claimed is:

1. An anti-loosen screw manufacturing method comprising:
combining a main die plate with a protruded die plate to form a combined die plate;
utilizing the main die plate of the combined die plate to execute a thread-rolling process on an outer circumferential surface of a shank portion to form an outer thread portion which includes a plurality of grooves; and
utilizing the protruded die plate of the combined die plate to execute an extrusion-forming process to form at least one or a plurality of laterally-extruded thread portions on a predetermined groove of the outer thread portion in the thread-rolling process;
wherein each of the laterally-extruded thread portions is formed by laterally extruding a first inclined wall of the predetermined groove of the outer thread portion with respect to a longitudinal direction thereof such that a first laterally-extruded portion is protruded in a first adjacent groove of the predetermined groove; and
wherein the laterally-extruded thread portion widens a width of the predetermined groove such that the first laterally-extruded portion is tightly engaged with a first inclined surface of a first groove of inner threads of a screw hole.

2. The anti-loosen screw manufacturing method as defined in claim 1, wherein each of the laterally-extruded thread portions is further formed by laterally extruding a second inclined wall of the predetermined groove of the outer thread portion with respect to the longitudinal direction thereof such that a second laterally-extruded portion is protruded in a second adjacent groove of the predetermined groove and is tightly engaged with a second inclined surface of a second groove adjacent to the first groove of the inner threads of the screw hole.

3. The anti-loosen screw manufacturing method as defined in claim 1, wherein two of the plurality of laterally-extruded thread portions has an included angle with respect to a longitudinal axis of the shank portion.

4. The anti-loosen screw manufacturing method as defined in claim 3, wherein the included angle is 180°, 120°, 90°, 72° or 60°.

5. The anti-loosen screw manufacturing method as defined in claim 1, wherein the plurality of laterally-extruded thread portions are equal-spaced apart to form a plurality of equal-spaced engaging points for engaging with the inner thread of the screw hole.

6. The anti-loosen screw manufacturing method as defined in claim 1, wherein the outer thread portion has at least one thermal treatment layer to intensify strength of the laterally-extruded thread portion.

7. The anti-loosen screw manufacturing method as defined in claim 1, wherein the laterally-extruded thread portion has a recession formed in a bottom surface of the groove and extended along the longitudinal direction thereof.

8. An anti-loosen screw comprising:
a shank portion provided with an outer circumferential surface;
an outer thread portion formed on the outer circumferential surface of the shank portion in a thread-rolling process, with the outer thread portion including a plurality of grooves; and
at least one or a plurality of laterally-extruded thread portions formed on a predetermined groove of the outer thread portion in the thread-rolling process;
wherein each of the laterally-extruded thread portions is formed by laterally extruding a first inclined wall of the predetermined groove of the outer thread portion with respect to a longitudinal direction thereof such that a first laterally-extruded portion is protruded in a first adjacent groove of the predetermined groove; and
wherein the laterally-extruded thread portion widens a width of the predetermined groove such that the first laterally-extruded portion is tightly engaged with a first inclined surface of a first groove of inner threads of a screw hole.

9. The anti-loosen screw as defined in claim 8, wherein each of the laterally-extruded thread portions is further formed by laterally extruding a second inclined wall of the predetermined groove of the outer thread portion with respect to the longitudinal direction thereof such that a second laterally-extruded portion is protruded in a second adjacent groove of the predetermined groove and is tightly engaged with a second inclined surface of a second groove adjacent to the first groove of the inner threads of the screw hole.

10. The anti-loosen screw as defined in claim 8, wherein two of the plurality of laterally-extruded thread portions has an included angle with respect to a longitudinal axis of the shank portion.

11. The anti-loosen screw as defined in claim 10, wherein the included angle is 180°, 120°, 90°, 72° or 60°.

12. The anti-loosen screw as defined in claim 8, wherein the plurality of laterally-extruded thread portions are equal-spaced apart to form a plurality of equal-spaced engaging points for engaging with the inner thread of the screw hole.

13. The anti-loosen screw as defined in claim 8, wherein the outer thread portion has at least one thermal treatment layer to intensify strength of the laterally-extruded thread portion.

14. The anti-loosen screw as defined in claim 8, wherein the laterally-extruded thread portion has a recession formed in a bottom surface of the groove and extended along the longitudinal direction thereof.
